(19) United States
(12) Patent Application Publication
(10) Pub. No.: US 2007/0259584 A1
(43) Pub. Date: Nov. 8, 2007

(54) BIODEGRADABLE POLYMER COMPOSITES AND RELATED METHODS

(76) Inventor: Ronald Whitehouse, (US)

Correspondence Address: Ronald Whitehouse, 4520 Orchid Circle, Plymouth, MN, 55446-2137, US

(21) Appl. No.: 11/744,548

(22) Filed: May 4, 2007

Related U.S. Application Data
(60) Provisional application No. 60/797,230, filed on May 4, 2006.

(51) Int. Cl. B27N 3/00; D04H 1/00

(52) U.S. Cl. 442/417; 156/62.2

(57) ABSTRACT

Biodegradable polymer composites resulting from the combination of a biodegradable polymer resin with a fibrous cellulose-based aggregate. The biodegradable polymer resin in this composite is substantially biodegradable and the aggregate and/or aggregates used are from renewable natural resources and are processed to produce aggregates of varying sizes. Methods of molding the biodegradable polymer composites are also disclosed.

### CLAIM TO PRIORITY

The present patent application claims priority to U.S. Provisional Patent Application No. 60/797,230, filed May 4, 2006, titled “Fibrous cellulose material combined with polylactic acid to form extruded or compression molded products,” which is incorporated herein by reference.

### FIELD OF THE INVENTION

The invention relates generally to biodegradable polymer composites. More particularly, in some embodiments the invention relates to a blend of a biodegradable polymer resin, e.g. polylactic acid and/or polyhydroxyalkanoate, and at least one fibrous cellulose-based renewable natural resource for moldable biodegradable polymer composites. Furthermore, the invention relates to methods of forming the biodegradable polymer composites using a biodegradable polymer resin and at least one fibrous cellulose-based renewable natural resource to produce moldable products.

### BACKGROUND OF THE INVENTION

The plastics manufacturing industry faces increasing levels of pressure and criticism from environmentalists and the general public for many reasons, including plastic products contributing to an ever-increasing pollution problem and burden on landfills due to their inherent longevity and non-degradability. Additionally, since the vast majority of plastic products are petroleum-based, and the price of oil is increasing due to increased demand from countries around the world, the price of plastic products are also increasing.

Concurrently, every year, in the natural developmental cycle of plant growth, billions of tons of fibrous cellulose-based components are generated, mature, age, and are discarded. The most apparent example in this category is the leaves of trees and other deciduous plants. Also, other fibrous cellulose-based waste is discarded during the processing of foods such as the outer shells of fruits and nut plants that are routinely removed during processing—e.g., peanut, pecan, and walnut shells. Like discarded plastic products, these natural cellulose-based components are often disposed of in landfills.

### SUMMARY OF THE INVENTION

In one aspect, the invention pertains to a biodegradable polymer composite comprising a biodegradable polymer resin and a fibrous cellulose-based aggregate.

In a further aspect, the invention relates to a biodegradable polymer composite comprising a biodegradable polymer resin selected from the group consisting of polylactide, polyhyrdoxyalkanoate, polyhydroxybutarate, polycaprolactone, polyglycolic acid, plastarch material, and combinations and a fibrous cellulose-based aggregate selected from the group consisting of peanut shells, walnut shells, pecan shells, sawdust, leaves, pine needles, straw, wood chips, cotton, rice hulls, coconut shells, bamboo, corn husks, corn stalks, newspaper, cardboard, grass, combinations thereof, and other fibrous cellulose-based aggregates from renewable natural resources.

In an additional aspect, the invention pertains to biodegradable polymer composite comprising a biodegradable polymer resin, a fibrous cellulose-based aggregate, and an auxiliary component such as a coloring agent, pigment, extender, strengthener, or filler.

In another aspect, the invention relates to a method of mixing a biodegradable polymer resin and a fibrous cellulose-based aggregate to form a biodegradable polymer composite by providing 5 to 50 parts by mass of at least one biodegradable polymer resin with 95 to 50 parts by mass of at least one fibrous cellulose-based aggregate to form a mixture of the biodegradable polymer resin and fibrous cellulose-based aggregate and extruding the mixture at a temperature sufficient to make the mixture extrudable wherein the composite total does not exceed 100 parts.

In an additional aspect, the invention pertains to a method for producing a biodegradable polymer composite product comprising a biodegradable polymer resin and a fibrous cellulose-based aggregate by providing 5 to 50 parts by mass of at least one biodegradable polymer resin selected from the group consisting of polylactide, polyhyrdoxyalkanoate, polyhydroxybutarate, polycaprolactone, polyglycolic acid, plastarch material, and combinations thereof; providing 95 to 50 parts by mass of at least one fibrous cellulose-based aggregate to form a mixture of the biodegradable polymer resin and fibrous cellulose-based aggregate selected from the group consisting of peanut shells, walnut shells, pecan shells, sawdust, leaves, pine needles, straw, wood chips, cotton, rice hulls, coconut shells, bamboo, corn husks, corn stalks, newspaper, cardboard, grass, combinations thereof, and other fibrous cellulose-based aggregates, mix-melting the biodegradable polymer resin and the fibrous cellulose-based aggregate in an extruder to form a mixture, extruding the mixture at a temperature sufficient to make the mixture extrudable, and molding the mixture into a product using a molding technique selected from the group consisting of injection molding, injection/compression molding, compression molding, thermoforming, extrusion molding, blow molding, and rotational molding, wherein the composite total does not exceed 100 parts.

In a preferred embodiment, the biodegradable polymer composite comprises at least one biodegradable polymer resin and at least one fibrous cellulose-based aggregate. The biodegradable polymer resin is selected from polylactide or polylalactic acid (PLA) (available from NatureWorks, LLC) or any compound which functions in the same way with the same result, such as modified polylactides or acids thereof, polyhyrdoxyalkanoate (PHA) (available from Metabolix), polyhydroxybutarate, polycaprolactone, polyglycolic acid (PGA), plastarch material (PSM) (available from PSM North America), and combinations thereof. The fibrous cellulose-based aggregate comprises at least one plant or plant byproduct that can be ground, pulverized, shredded, crushed, or otherwise reduced to an aggregate that can have sizes ranging from about 10 μm to about 50 mm with other sizes within this range contemplated. Such fibrous cellulose-based aggregates include, for example, peanut shells, walnut shells, pecan shells, sawdust, leaves, pine needles, straw, wood chips, cotton, rice hulls, coconut shells, bamboo, corn husks, corn stalks, newspaper, cardboard, various grasses such as switchblade grass, and coffee chaff. Other fibrous cellulose-based aggregates are also contemplated.

In another preferred embodiment, the fibrous cellulose-based aggregate can be dried using drying techniques such as dry kilns, dehumidification kilns, solar kilns, sun drying, air drying, radiated heat drying, steam kilns, and vacuum kilns until the desired moisture content is achieved. Other techniques of drying the fibrous cellulose-based aggregate are also contemplated. In an alternative embodiment, the moisture content of the fibrous cellulose-based aggregate is not controlled.

In another preferred embodiment, the ratio of biodegradable polymer resin fibrous cellulose based aggregate in the biodegradable polymer composite is from about 5/95 to about 50/50 by mass, with intermediate ratios contemplated such as 10/90, 15/85, 20/80, 25/75, 30/70, 35/65, 40/60, 45/55 and other increments therebetween, depending upon the desired properties of the resultant biodegradable polymer composite.

In another preferred embodiment, the biodegradable polymer composite also comprises at least one other additive component such as coloring agents, pigments, colorants, biodegradable polymer resin extenders, crosslinking agents, stabilizers, ultraviolet stabilizers, fillers, carbon black, strengtheners, and other conventional materials that are used in cellulosic and/or thermoplastic compounds. An example of a colorant is a liquid colorant available from PolyOne Corporation, which is based upon natural raw materials. Examples of inorganic fillers include talc, calcium carbonate, kaolin clay, magnesium oxide, titanium dioxide, silica, mica, barium sulfate, and any other suitable materials. Commonly used cross-linking agents include polyurethanes, such as isocyanates, phenolic resins, unsaturated polyesters, and epoxy resins. An example of a strengthener includes BioMax Strong® provided by Dupont Co.

In a preferred embodiment, the method of mixing the components to form the biodegradable polymer composite is not particularly limited, and includes melt-mixing the biodegradable polymer resin and the fibrous cellulose-based aggregate using an extruder or twin-extruder, using a known mixer such as a ribbon blender or tumbler, and other methods known to one of ordinary skill in the art.

In a preferred embodiment, the biodegradable polymer composite can be molded using the usual molding methods for making plastics and composites, such as injection molding, injection/compression molding, compression molding, thermoforming, extrusion molding, blow molding, and rotational molding. Other types of molding known to one of ordinary skill in the art are also contemplated.

In a preferred embodiment, the additive is either a solid or liquid form. The solid form is comprised of either a waxy prill or a master batch, where the carrier is the same material being used as the main resin, such as polylactide. Additives added in the liquid form are delivered via a pump and mixer combination where the raw biodegradable polymer resin mix with the additive before entering the feed section of the extruder.

In another preferred embodiment, the mixed biodegradable polymer composite is extruded into pellets. The pelletized biodegradable polymer composite is then used in the molding methods above.

The embodiments described above are intended to be illustrative and not limiting. Additional embodiments are within the claims below. Although the present invention has been described with reference to specific embodiments, workers skilled in the art will recognize that changes may be made in form and detail without departing from the spirit and scope of the invention. In addition, the terms including, comprising and having as used herein are intended to have broad non-limiting scope.

What is claimed is:

1. A biodegradable polymer composite comprising at least one biodegradable polymer resin and at least one fibrous cellulose-based aggregate.

2. The biodegradable polymer composite of claim 1 wherein the at least one biodegradable polymer resin is selected from the group consisting of polylactide, polyhyrdoxyalkanoate, polyhydroxybutarate, polycaprolactone, polyglycolic acid, plastarch material, and combinations thereof.

3. The biodegradable polymer composite of claim 2 wherein the biodegradable polymer resin is polylactide.

4. The biodegradable polymer composite of claim 1 wherein the at least one fibrous cellulose-based aggregate is selected from the group consisting of peanut shells, walnut shells, pecan shells, sawdust, leaves, pine needles, straw, wood chips, cotton, rice hulls, coconut shells, bamboo, corn husks, corn stalks, newspaper, cardboard, grass, and combinations thereof.

5. The biodegradable polymer composite of claim 4 wherein the biodegradable polymer resin is polylactide and the fibrous cellulose-based aggregate is peanut shells.

6. The biodegradable polymer composite of claim 4 wherein the fibrous cellulose-based aggregate has a size in the range from about 10 μm to about 50 mm.

7. The biodegradable polymer composite of claim 1 comprising 5-50% by mass of the biodegradable polymer resin based on the biodegradable polymer resin.

8. The biodegradable polymer composite of claim 1 further comprising at least one component selected from the group consisting of a coloring agent, a pigment, a colorant, a biodegradable polymer resin extender, a crosslinking agent, a stabilizer, a ultraviolet stabilizer, a filler, carbon black, a strengthener, and any combinations thereof.

9. A method of forming a biodegradable polymer composite comprising:
providing 5 to 50 parts by mass of at least one biodegradable polymer resin with 95 to 50 parts by mass of at least one fibrous cellulose-based aggregate mixing the biodegradable polymer resin with the fibrous cellulose-based aggregate to form a mixture of the biodegradable polymer resin and fibrous cellulose-based aggregate; and
extruding the mixture at a temperature sufficient to make the mixture extrudable; wherein said composite total does not exceed 100 parts.

10. The method of claim 9 wherein the at least one biodegradable polymer resin is selected from the group consisting of polylactide, polyhyrdoxyalkanoate, polyhydroxybutarate, polycaprolactone, polyglycolic acid, plastarch material, and combinations thereof.

11. The method of claim 9 further comprising adding an extender to the mixture.

12. The method of claim 9 further comprising adding a strengthener to the mixture.

13. The method of claim 9 wherein the at least one fibrous cellulose-based aggregate has a size in the range from about 10 μm to about 50 mm.

14. The method of claim 9 further comprising pelletizing the extruded mixture into one or more pellets.

15. The method of claim 14 further comprising molding the pellets into an article using a technique from the group consisting of injection molding, injection/compression molding, compression molding, thermoforming, extrusion molding, blow molding, and rotational molding.

16. The method of forming a biodegradable polymer composite product comprising:
providing 5 to 50 parts by mass of at least one biodegradable polymer resin selected from the group consisting of polylactide, polyhyrdoxyalkanoate, polyhydroxybutarate, polycaprolactone, polyglycolic acid, plastarch material, and combinations thereof;
providing 95 to 50 parts by mass of at least one fibrous cellulose-based aggregate to form a mixture of the biodegradable polymer resin and fibrous cellulose-based aggregate selected from the group consisting of peanut shells, walnut shells, pecan shells, sawdust, leaves, pine needles, straw, wood chips, cotton, rice hulls, coconut shells, bamboo, corn husks, corn stalks, newspaper, cardboard, grass, and combinations thereof;
mix-melting the biodegradable polymer resin and the fibrous cellulose-based aggregate in an extruder to form a mixture;
heating the mixture to an extrusion temperature;
extruding the mixture at a temperature sufficient to make the mixture extrudable; and
molding the mixture into a product using a molding technique selected from the group consisting of injection molding, injection/compression molding, compression molding, thermoforming, extrusion molding, blow molding, and rotational molding, wherein the composite total does not exceed 100 parts.

17. The method of claim 16 wherein the mixture is extruded into pellets that is feedstock for the molding technique.

18. The method of claim 16 further comprising adding at least one additive to the mixture wherein the additive is selected from the group consisting of a coloring agent, a pigment, a colorant, a biodegradable polymer resin extender, a crosslinking agent, a stabilizer, a ultraviolet stabilizer, a filler, carbon black, a strengthener, and any combinations thereof.

19. The method of claim 18 wherein the additive is a liquid colorant that is added to the mixture before entering the feed section of the extruder.

20. The method of claim 16 wherein the biodegradable polymer resin is polylactide.

21. The method of claim 16 further comprising drying the fibrous cellulose-based aggregate before providing it into the mixture.
